(19) United States
(12) Patent Application Publication
(10) Pub. No.: US 2025/0249982 A1
(43) Pub. Date: Aug. 7, 2025

(54) Convertible Blind and Boat

(71) Applicant: Robert E. Marsh, Kansas City, MO (US)

(72) Inventor: Robert E. Marsh, Kansas City, MO (US)

(21) Appl. No.: 18/676,674

(22) Filed: May 29, 2024

Related U.S. Application Data
(60) Provisional application No. 63/470,246, filed on Jun. 1, 2023.

(51) Int. Cl. B63B 3/12; B63B 3/02

(52) U.S. Cl. CPC B63B 3/12; B63B 3/02

(57) ABSTRACT

This invention is a convertible boat and blind made of a substantially flat sheet of foldable material that in one configuration may be folded into a boat and in a second configuration may be folded into a blind. The invention may also be folded into an optional third storage configuration.

### BACKGROUND OF THE INVENTION

Outdoor enthusiasts often utilize a boat to transport themselves and/or their gear to a location to observe or hunt birds or other animals. Once they reach that location it is often desirable to utilize a blind structure to conceal themselves from birds or other animals. In many cases the boat and the blind are two separate things, with the boat used to transport people and/or gear to a location where a separate blind is set up. In this case it is necessary to attempt to conceal the boat while the separate blind is utilized—often with some distance between the unused boat and the blind. In some cases a boat is made into a blind by adding structure to the boat, but it remains a boat, and these boat blinds are typically heavy and cumbersome and difficult to conceal.

As used in this description, a “boat” is a floating structure with a watertight bottom that can hold people and/or gear for transportation over water or over a shallow wet area where it is too shallow for the boat to float but where having a watertight bottom is necessary. A “blind” is a structure having at least three faces or panels that are typically oriented vertically so that a person can be concealed behind the faces or panels. A “blind” as used in this description does not have a watertight bottom. A boat and a blind are two very different structures.

### SUMMARY OF THE INVENTION

This invention comprises a sheet of rigid foldable material that in one configuration is folded into a boat and in a second configuration is folded into a blind. Optionally a third configuration is a storage configuration designed to minimize the storage space required when the invention is not in use as either a boat or a blind, such as when being transported in a vehicle or stored between uses. This invention is an easily transported, light weight structure that conveniently serves as both a boat and a blind.

### BRIEF DESCRIPTION OF DRAWINGS

FIG. 1 is a top view of the sheet of the present invention showing boat folds and blind folds.

FIG. 2 is side view of a boat configuration.

FIG. 3 is a top view of a boat configuration.

FIG. 4 is a top view of the sheet folded in the blind configuration.

FIG. 5 is a top view of the sheet folded in another blind configuration.

### DETAILED DESCRIPTION OF THE INVENTION

The convertible folding boat and blind of this invention is constructed of an initially substantially flat sheet of foldable material, preferably a twin-walled extruded corrugated polypropylene or polyethylene sheet such as that sold under the trademark CoroPlast™, or other suitable materials known in the art. While this description may refer to a boat converted into a blind or a blind converted into a boat, both configurations are equally important to the purpose of the invention. The flat sheet is preferably approximately rectangular, having a length greater than its width as described in more detail below.

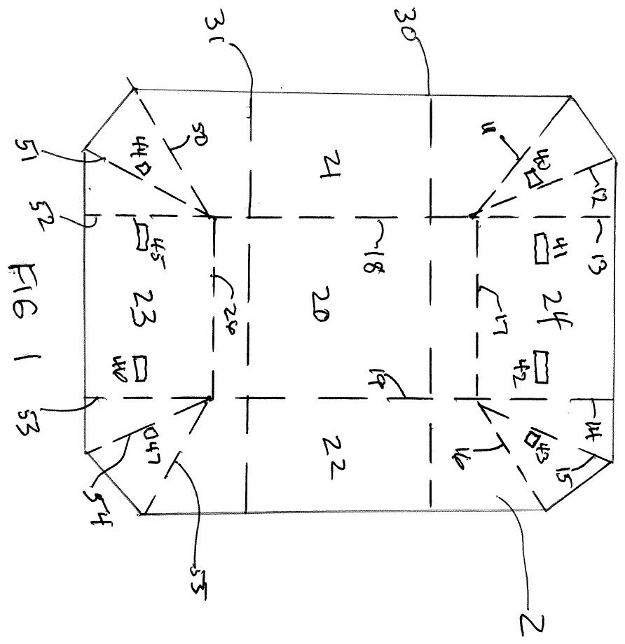

Preformed creases or folds are placed in suitable locations in the sheet for folding the sheet into the boat configuration or the blind configuration, or optionally, the storage configuration. The creases may be pre-formed with a suitable steel die rule or other manners known in the art. One set of creases define the folds necessary to fold the sheet into a boat (the Boat Folds) and another set of creases define the folds necessary to fold the sheet into a blind (the Blind Folds). FIG. 1 shows sheet 2 with Boat Folds 11, 12, 13, 14, 15, 16, 17, 18, 19, 26, 50, 51, 52, 53, 54, and 55, such that when the sheet is folded at the Boat Folds sheet portion 20 is the bottom of the boat and sheet portions 21, 22, 23, and 24 are the boat sides. FIG. 1 also shows Blind Folds 30 and 31.

Optional creases necessary to fold the sheet into the optional storage configuration (Optional Storage Folds) are not shown in FIG. 1 but could be added to the sheet if desired in a manner and locations known to one skilled in the art. In the storage configuration there is no internal space for gear or persons (as would be the case in a boat or a blind) and the total volume of the folded sheet is minimized. Preferably the shape of the folded sheet in the storage configuration is a rectangular prism.

When the sheet is folded in a desired configuration, the folded position is retained using connectors which may be of various types, including ratchet strap/buckle mechanisms, hoop and loop connection straps, straps with snap buttons, or various other connection methods known in the art. Each connector connects portions of the folded sheet to each other, thereby causing the sheet to remain folded in the desired configuration and retain either the boat or blind shape (or, if utilized, the separate storage configuration shape). When the connectors are separated or released the creases will tend to unfold and permit conversion of the sheet into another configuration. FIG. 1 shows the connection points of connectors at 40, 41, 42, 43, 44, 45, 46 and 47. The straps associated with these connectors allow for tightening to allow for stretching of the connectors and optionally repositioning of the panels of the folded sheet.

It may be desirable to mark the creases to indicate which configuration they enable to assist the user in folding the sheet properly. Colored strips painted or taped over the creases are one method effective for this purpose.

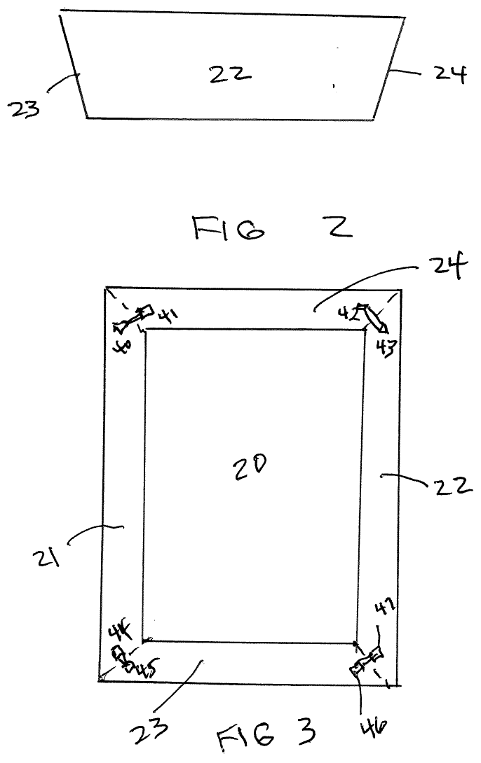

In the boat configuration created by folding the sheet using the Boat Folds a functional boat shape is created. FIGS. 2 and 3 show additional views of the boat configuration created by folding the sheet 2 on the Boat Folds shown in FIG. 1. One boat shape is shown in FIG. 1, but other boat shapes could be utilized, including shapes representing a pirogue or canoe style boat. The boat configuration can be used to transport a person inside the boat, or may be utilized only to transport gear and dogs inside the boat with a person wading alongside it.

The length of the boat is defined by the length of the sheet (which is preferably greater than its width) allowing for the portions of the sheet that make up the stern and bow sidewalls of the boat. For example, from a sheet 8 feet long a six foot long boat with one foot stern and bow sidewalls could be folded. From a sheet 5 feet wide a 3 foot wide boat (with one foot sidewalls) could be folded.

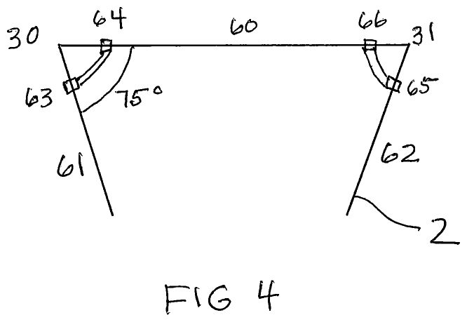

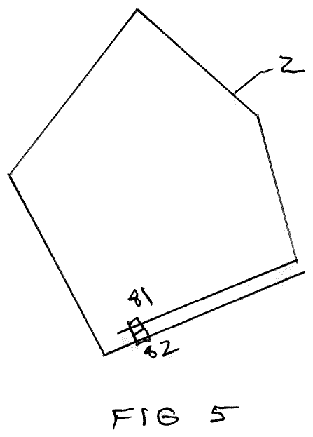

As shown in FIG. 4, sheet 2 is folded at Blind Folds 30 and 31 to create a blind with three panels—front panel 60 and side panels 61 and 62. Blind folds are held in the folded position with connectors such as buckles and straps attached at 63. 64. 65 and 66. In the blind configuration shown in FIG. 2 the Blind Folds are approximately parallel to each other, and are preferably perpendicular to the long axis of the sheet. In this blind configuration the sheet (folded on the Blind Folds) is positioned so that the width of the sheet (which is less than its length) is positioned vertically. As an example of blind dimensions, with a sheet 5 feet wide and 8 feet long, a 3 panel blind could be formed having a front panel 3 feet wide and side panels each 2.5 feet wide. Alternatively, the blind configuration could have 3 equal width faces each 2.67 feet wide and roughly 5 feet high. The exact height of the blind configuration would be affected, however, by any optional partial roof or floor as described below, which could, for example, result in a three panel blind closer to 4 feet high.

Alternatively, one of the panels could be split in half to create a “door” area that would open and close on the adjacent folds for entry of a person into the blind.

More than three panels would also be suitable for a blind configuration. In the embodiment shown in FIG. 5 the blind configuration has 6 panels, each having a width of x/6, where x is the overall length of the sheet. The two end panels are overlapped at attached with connectors 81 and 82 as shown in FIG. 5 creating a blind having roughly a pentagon cross section. Other cross sections, including but no limited to square and hexagonal, would also be suitable.

It is desirable to allow for modification of fold angles at the corners of the blind by adjustment of the length of the buckle and straps. For example, in a three panel blind configuration of FIG. 4, the user may decide that the desired interior angle between the front panel and each of the two side panels is 75°. As shown in FIG. 3, the length of straps 63 and 65 would then be adjusted to hold these panels at that angle.

The blind configuration of this invention is free standing—in that no separate support frame is needed. While stakes for attachment to the ground may be desired (especially in windy conditions) and straps may be attached to the sheet for this purpose, the sheet material itself is sufficiently rigid to the make the blind free standing.

In an alternative embodiment, one or more additional creases and/or additional sheet material is provided to permit folding of a portion of the sheet into a partial “roof” that would fold to conceal a person in the blind from a bird flying overhead. Preferably such a roof would fold on a crease at the top of the front panel of the blind configuration. The roof may be configured with straps and biasing means known in the art to enable the roof to spring into a lower position (folding in front of the front panel) out of the way to allow a person in the blind to quickly stand up. Suitable connectors would hold the partial roof in position.

Similarly, the bottom of the blind panels could include a partial floor created by folding the bottom of the panels toward the interior of the blind. These floor panels would facilitate staking the folded blind in position. In addition, added connectors between the partial roof or floor sections and/or blind panels would increase blind stability.

Other desirable components for the convertible boat and blind would include coloration suitable for concealment in vegetation or other hunting conditions and elastic brush holders for holding grasses and other brush to camouflage the invention in either the boat or blind position.

One important design consideration is whether in the boat configuration the boat will transport people, dogs and/or gear. Where the weight load in the boat will be significant (more than 25 lbs per square foot) a second layer of suitable material should be used to reinforce the sheet in the portion that would be the bottom of the boat. The material used for the second layer could be the same as the primary sheet, but with the corrugation, if applicable, running perpendicular to the corrugation of the primary sheet at the location where the weight load would be significant—such as where a person would be standing when poling the boat. Alternatively, the material of the second layer could be a different rigid material the selection of which would be well known in the art.

It should be noted that in some situations, it is acceptable and even desirable that the creases used for folding the sheet into the blind configurations utilize some of the same creases used for the boat configuration.

Similar connectors are used to hold the folded sheet in the storage configuration of this invention, and would supplement the boat and blind connectors discussed above in a manner known to one skilled in the art.

In other blind embodiments the panels of the blind configuration would not be exactly vertical, but would be an angles defined by the positioning of the Blind Folds. For example on one such embodiment the planes of the panels of the folded blind could be aligned to hypothetically converge at an point above the folded sheet, creating a folded blind that is a partial pyramid. Other suitable blind shapes and geometry would be known to one skilled in the art.

1. A convertible boat and blind comprising a sheet of rigid foldable material having multiple preformed creases, wherein folding the sheet on one set of creases creates a boat configuration and folding the sheet on another set of creases creates a blind configuration.

2. The convertible boat and blind of claim 1, further comprising connectors for holding the folded sheet in each of said configurations.

3. The convertible boat and blind of claim 1, further comprising preformed storage creases wherein folding the sheet on said storage creases results in a third rectangular prism configuration.

4. The convertible boat and blind of claim 1, said sheet comprising a corrugated extruded polypropylene sheet.

5. The convertible boat and blind of claim 1, said sheet comprising a corrugated extruded polyethylene sheet.

6. The convertible boat and blind of claim 1, wherein said blind configuration has at least 3 panels.

7. A sheet of rigid foldable material having multiple preformed creases, wherein folding the sheet on one set of creases creates a boat and folding the sheet on another set of creases creates a blind.

8. The sheet of claim 7, further comprising connectors for holding the folded sheet in its configuration as either a boat or blind.

9. The sheet of claim 7, further comprising preformed storage creases wherein folding the sheet on said storage creases results in a third rectangular prism configuration.

10. The sheet of claim 7, said sheet comprising a corrugated extruded polypropylene sheet.

11. The sheet of claim 7, said sheet comprising a corrugated extruded polyethylene sheet.

12. The sheet of claim 7, wherein said blind configuration has at least 3 panels.
